(19) United States
(12) Patent Application Publication
(10) Pub. No.: US 2024/0161145 A1
(43) Pub. Date: May 16, 2024

(54) INFORMATION PROCESSING APPARATUS

(71) Applicant: TOYOTA JIDOSHA KABUSHIKI KAISHA, Toyota-shi (JP)

(72) Inventors: Kenji YAMAGUCHI, Miyoshi-shi (JP); Yohei NAKANISHI, Nagoya-shi (JP); Yu HAMADA, Nagoya-shi (JP)

(73) Assignee: TOYOTA JIDOSHA KABUSHIKI KAISHA, Toyota-shi (JP)

(21) Appl. No.: 18/508,580

(22) Filed: Nov. 14, 2023

(30) Foreign Application Priority Data
Nov. 16, 2022 (JP) 2022-183725

(51) Int. Cl. G06Q 30/0207; G06Q 30/0601

(52) U.S. Cl. CPC G06Q 30/0224; G06Q 30/0621; G06Q 30/0643

(57) ABSTRACT

An information processing apparatus comprises a controller configured to execute, as a specification of a vehicle to be ordered, receiving order data specifying a first body color and a first vehicle model from a user, and determining a content of an incentive to be provided to the user based on order records of the first vehicle model having the first body color in a past predetermined period.

### CROSS REFERENCE TO THE RELATED APPLICATION

This application claims the benefit of Japanese Patent Application No. 2022-183725 filed on Nov. 16, 2022, which is hereby incorporated by reference herein in its entirety.

### BACKGROUND

### Technical Field

The present disclosure relates to an information processing apparatus.

### Description of the Related Art

A technique for changing the color of the vehicle body be overcoating the body of a car with a peelable coating film is known (see, for example, Japanese Patent Laid-Open 2022-059901).

### SUMMARY

The purpose of the present disclosure is to provide incentives according to the body color to users who purchase vehicles.

The first aspect of the present disclosure is an information processing apparatus having a controller configured to execute, as a specification of a vehicle to be ordered, receiving order data specifying a first body color and a first vehicle model from a user, and determining a content of an incentive to be provided to the user based on order records of the first vehicle model having the first body color in a past predetermined period.

Another aspect of the present disclosure is a method executed by the information processing apparatus, a program for causing the method to be executed by a computer, or a computer-readable storage medium in which the program is stored non-temporarily.

According to the present disclosure, an incentive according to the body color can be provided to a user who purchases a vehicle.

### BRIEF DESCRIPTION OF THE DRAWINGS

FIG. 1 is a diagram explaining the outline of the vehicle order system.

FIG. 2 is a diagram for explaining the configuration of a contract server and a user terminal.

FIG. 3A to 3C show examples of order data, basic color data, and top coat color data.

FIG. 4A to 4B are outline diagrams of painting with an easily peelable paint.

FIG. 5 shows a flowchart of the process executed by the contract server.

FIG. 6A to 6C show examples of a screen for specifying the body color.

FIG. 7 is a flowchart of the process executed in step S21.

FIG. 8 shows an example of data for calculating incentives.

### DESCRIPTION OF THE EMBODIMENTS

A technique for painting an automobile using a paint peelable be peeled off after the fact is known. A peelable paint is a paint that forms a coating film that can be easily peeled off from the vehicle body by applying force from the outside. For example, by applying a peelable paint to a vehicle having a predetermined body color, any vehicle can be changed to the user's preferred color. As a result, for example, when ordering a vehicle, it is possible to select a body color that is popular in the market and then overcoat it with the user's favorite color. Unlike the overcoat color set for each vehicle model, the paint that is overpainted after the fact can have many color variations.

By the way, when ordering a vehicle, an image of a vehicle having a specified body color may be provided as a sample in order to indicate a concrete image. However, when easily peelable paint becomes widespread, there may be cases where there is no sample image corresponding to the body color desired by the user because there are many color variations. For example, when a certain body color is specified for a certain vehicle model, if the combination is extremely small, there is no corresponding sample image and the appearance of the vehicle cannot be presented.

One way to solve this problem is, for example, to have the user who actually purchased the vehicle provide an external image of a sample vehicle. The information processing apparatus according to the present disclosure determines the incentive for providing an image according to the body color.

The information processing apparatus according to the first aspect of the present disclosure has a controller configured to execute, as a specification of a vehicle to be ordered, receiving order data specifying a first body color and a first vehicle model from a user, and determining a content of an incentive to be provided to the user based on order records of the first vehicle model having the first body color in a past predetermined period.

The order data is data that specifies the model and body color of the vehicle to be ordered.

When the order record of the first vehicle model having the first body color are small in the past, it is assumed that the sample image has not been sufficiently accumulated because the distribution amount of the vehicle having the body color is small. Therefore, the controller may increase the amount of the incentive as the order amount of the first vehicle model having the first body color in the past predetermined period is smaller.

According to such a configuration, more incentives can be provided to users who select a body color with a lower sales volume. That is, it can provide motivation to provide an external image of the vehicle.

The controller may determine to provide the incentive to the user on the condition that the user agrees to provide an external image of the vehicle having the first body color.

Further, the controller may acquire the order amount of the first vehicle model in the past predetermined period by body color, and based on this, determine the order record of the vehicle having the first body color. The order record can be acquired, for example, from a server device or a database that manages vehicle order information.

The first body color may be a body color realized by be overcoating an easily peelable paint to the vehicle.

Further, the controller may determine to provide the incentive to the user on the condition that the designated first body color is a body color realized by applying an easily peelable paint to the vehicle.

The easily peelable paint is a paint that forms a peelable coating film as described above. The easily peelable paint may be one in which the paint layer itself peeled off, or may consist of a peelable layer and a layer of paint formed on the layer. The body color of the vehicle can be changed by painting the vehicle with an easily peelable paint and peeling off the paint after the fact.

The color variations of the easily peelable paint may be more than the color variations set for the vehicle, and in such cases, it may be difficult to collect sample images for all body colors. Therefore, it may be determined to provide an incentive on the condition that the first body color is a color realized by an easily peelable paint.

Specific embodiments of the present disclosure will be described below on the basis of the drawings. The hardware configuration, module configuration, functional configuration, etc. described in each embodiment are not intended to limit the technical scope of disclosure to them unless otherwise specified.

### First Embodiment

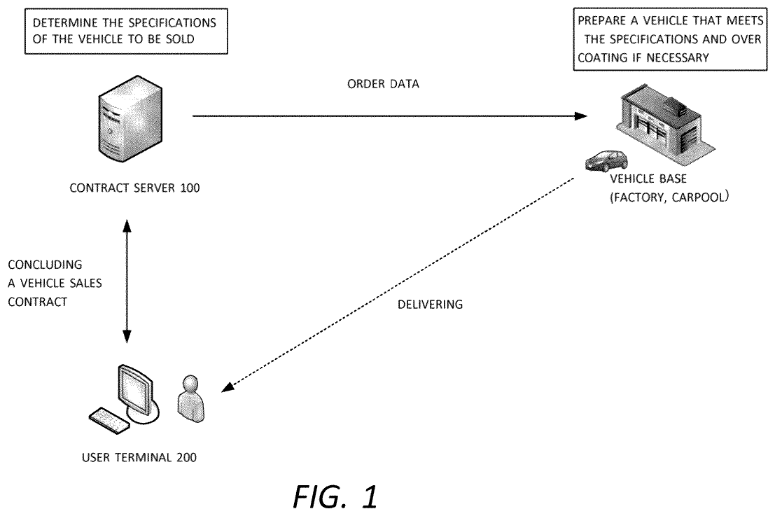

An outline of the vehicle ordering system according to the first embodiment will be described with reference to FIG. 1. The vehicle ordering system according to the present embodiment includes a contract server 100 and a user terminal 200.

The contract server 100 is a server device that concludes a sales contract for a vehicle with a user.

The contract server 100 determines the specifications of the vehicle to be sold to the user by interacting with the user terminal 200 and concludes a sales contract.

The user terminal 200 is a computer used by a user who purchases a vehicle. The user can access the contract server 100 via the user terminal 200 and apply for a vehicle sales contract. Here, it is assumed that the sales contract is performed online, but the sales contract may be performed at a store (for example, a car dealer). In this case, the user terminal 200 may be a computer installed in a store.

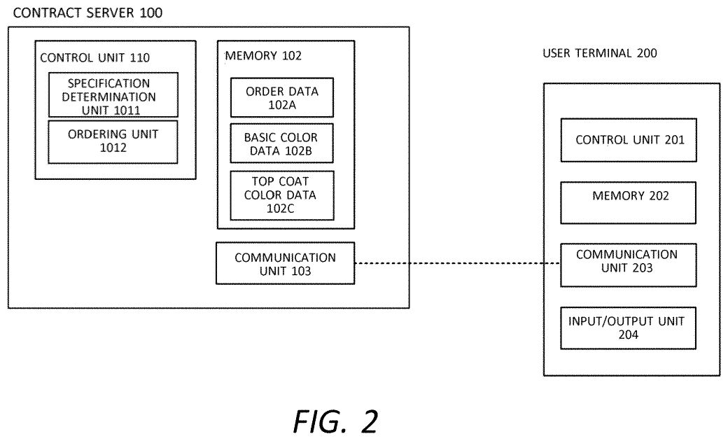

FIG. 2 is a diagram showing in more detail the components of the contract server 100 and the user terminal 200 included in the vehicle ordering system according to the present embodiment. Here, first, the user terminal 200 will be described.

The user terminal 200 is a computer used by an individual, such as, for example, a personal computer, a smartphone, a mobile phone, a tablet computer, and a personal information terminal. The user terminal 200 includes a controller 201, a storage 202, a communication unit 203, and an input/output unit 204.

The controller 201 is an arithmetic unit that controls the control performed by the user terminal 200. The controller 201 can be realized by an arithmetic processing unit such as a CPU (Central Processing Unit).

The controller 201 has a function of accessing the contract server 100 and performing interaction. The function may be realized by the controller 201 executing a web browser operating on the user terminal 200 or a dedicated application software.

The storage 202 includes a main memory and an auxiliary storage device. The main memory is a memory in which a program executed by the controller 201 and data used by the control program are deployed. The auxiliary storage device is a device that stores a program executed in the controller 201 and data used by the control program. The auxiliary storage device may store a program executed by the controller 201 packaged as an application. The auxiliary storage device may also store an operating system for executing these applications. The program stored in the auxiliary storage device is loaded into the main memory and executed by the controller 201, and the process described herein is performed.

The main memory may include RAM (Random Access Memory) or ROM (Read Only Memory). The auxiliary storage device may include an EPROM (Erasable Programmable ROM) or a hard disk drive (HDD, Hard Disk Drive). Further, the auxiliary storage device may include removable media, ie portable recording media.

The communication unit 203 is a wireless communication interface for connecting the user terminal 200 to the network. The communication unit 203 is configured to be able to communicate with the contract server 100 via a mobile communication network such as wireless LAN or 3G, 4G, or 5G, for example. The input/output unit 204 is a unit that accepts input operations performed by the user and presents information to the user. In the present embodiment, the input/output unit 204 includes one touch panel display. That is, the input/output unit 204 includes a liquid crystal display and its control means, and a touch panel and control means thereof.

Next, the contract server 100 will be described.

The contract server 100 is a server device that concludes a vehicle sales contract based on the result of an interaction with the user terminal 200.

In the present embodiment, the contract server 100 may be configured to be able to execute a Web server for interacting with the user terminal 200. In this case, for example, the user terminal 200 can perform the contract conclusion procedure by accessing the Web server using a browser. The contract server 100 may provide services by means other than the Web server. For example, a service that interacts with dedicated application software installed on the user terminal 200 using a predetermined protocol may be executed on the contract server 100.

The contract server 100 can be configured as a computer having a processor such as a CPU or GPU, a main storage device such as RAM or ROM, and an auxiliary storage device such as an EPROM, a hard disk drive, or removable media. The auxiliary storage device stores an operating system (OS), various programs, various tables, and the like, loads the program stored therein into the work area of the main memory, executes it, and each component unit is controlled through the execution of the program. Thereby, as described later, each function corresponding to a predetermined purpose can be realized. However, some or all functions may be realized by hardware circuits such as ASICs and FPGAs.

The contract server 100 is configured by having a controller 101, a storage 102, and a communication unit 103.

The controller 101 is an arithmetic unit that controls the control performed by the contract server 100. The controller 101 can be realized by an arithmetic processing unit such as a CPU.

The controller 101 includes two functional modules, a specification determination unit 1011 and an ordering unit 1012. Each functional module may be realized by executing the stored program by the CPU.

The specification determination unit 1011 determines the specifications of the vehicle to be bought and sold by interacting with the user terminal 200. The specification determination unit 1011 determines the following matters as the specifications of the vehicle.
(1) Model and grade
(2) body color
(3) Others (Options, etc.)

In the following description, the combination of vehicle model and grade is simply referred to as a vehicle model. Sales include sales that are premised on returning or selling the vehicle after a predetermined period of time, such as sales with residual value setting credits and lease sales.

Here, the body color is the color of the body desired by the user. The body color does not necessarily have to be a single color. The body color may be two-tone or with an accent color.

In the following description, the body color originally owned by the vehicle is referred to as the first body color. Further, the color of the vehicle body desired by the user is referred to as the desired body color, and the body color overpainted by the easily peelable paint is referred to as the second body color.

Further, the specification determination unit 1011 acquires the order history of the vehicle in the past predetermined period and determines the content of the incentive provided to the user who orders the vehicle based on the order history.

As described above, it is assumed that many color variations will be prepared in the sales form that can overcoat the desired color on the vehicle to be ordered by the easily peelable paint. In such a case, it is preferable to provide the user with information such as what color the vehicle will have when the paint top coat is actually applied. In the normal sales form, a method is often taken to provide sample images that indicate the appearance of the vehicle for each base color. However, if there are many color variations (for example, there are more than 100 colors), the user may not be able to prepare a sample image of desired body color.

Therefore, the contract server 100 according to the present embodiment determines how rare the vehicle body color desired by the user is when receiving an order for the vehicle, and when a rarer color is selected, more incentives are given to the user. By using this incentive as consideration for providing exterior images of vehicles (vehicles overpainted with specified colors), it can be expected that more exterior images can be collected.

Incentives are typically discount coupons and points that can be used at online services or stores. The incentive may be electronic money or gift certificates. These may be addressed to the purchase price of options accompanying the vehicle. Further, if the vehicle is leased and sold, an incentive may be used as a discount on the monthly fee. The incentive may be granted on the condition that the user provides an external image of the vehicle. For example, when ordering a vehicle, the user may be asked whether or not to agree to provide an image, and if there is consent, an incentive may be granted.

The ordering unit 1012 generates data (order instruction data) for instructing the ordering of a vehicle based on the specifications determined by the specification determination unit 1011 and transmits it to an appropriate vehicle base. When the vehicle is a stock vehicle, the vehicle base can be a carpool to which the vehicle belongs. Further, when the vehicle is made-to-order, the vehicle base can be a vehicle manufacturing factory. Further, when the specification determination unit 1011 determines to use an easily peelable paint, the ordering unit 1012 includes a vehicle painting instruction using an easily peelable paint in the order instruction data.

For example, when a desired vehicle body color (for example, red) different from the first body color (for example, white) is specified, the ordering unit 1012 includes an instruction to the effect that “a vehicle having a white body color is overcoated with red and shipped” in the order instruction data.

The storage 102 includes a main storage device and an auxiliary storage device. The main storage device is a memory in which a program executed by the controller 101 and data used by the control program are deployed. The auxiliary storage device is a device that stores a program executed in the controller 101 and data used by the control program.

The storage 102 stores the order data 102A, the basic color data 102B, and the top coat color data 102C.

The order data 102A is data indicating details of the vehicle to be ordered, and is generated by the ordering unit 1012.

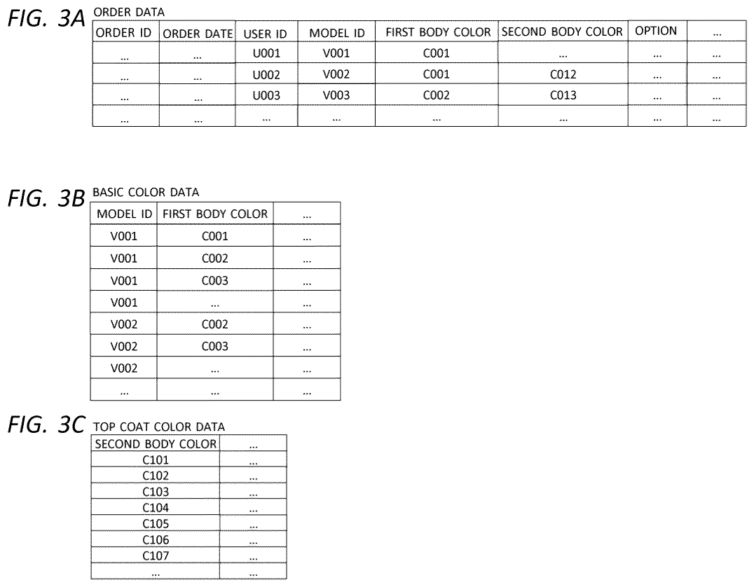

FIG. 3A is an example of order data 102A. As shown, the order data 102A includes fields for order ID, order date, user ID, model ID, first body color, second body color, and options.

The order ID field stores a unique identifier for each vehicle order. The order date field stores the date the order was ordered. The user ID field stores an identifier that uniquely identifies the user who orders the vehicle. The model ID field stores an identifier that uniquely identifies the vehicle model.

The first body color field stores an identifier of the original body color (first body color) of the target vehicle. The second body color field stores an identifier of the vehicle body color (second body color) that is overcoated by the easily peelable paint. Note that if easily peelable paint is not used, the value is not stored in the second body color field.

The option field stores information (for example, option) related to other specifications.

The basic color data 102B is data related to the base color set for each vehicle model.

FIG. 3B is an example of basic color data 102B. As shown, the basic color data 102B has a model ID and a first body color field.

The model ID field stores an identifier that uniquely identifies the vehicle model. The first body color field stores the identifier of the first body color set as the base color of the target vehicle model. For example, in the illustrated example, the vehicle model having the identifier V001 is set with three base colors: C001, C002, and C003.

The basic color data 102B may include color sample data for each body color and sample external image data.

Further, the storage 202 stores the top coat color data 102C. The top coat color data 102C is data related to a vehicle body color that can be overcoated with an easily peelable paint. An example of the top coat color data 102C is shown in FIG. 3C. As shown, the top coat color data 102C includes an identifier of a body color (second body color) that can be overpainted. The top coat color data 102C may include color swatch data.

Each of the above-described data may be constructed by a database management system (DBMS) program executed by the processor managing the data stored in the storage device. In this case, each data can be, for example, a relational database.

The communication unit 103 is a communication interface for connecting the contract server 100 to the network. The communication unit 103 includes, for example, a network interface board and a wireless communication interface for wireless communication.

Note that the configuration shown in FIG. 2 is an example, and all or part of the illustrated function may be executed using a specially designed circuit. Further, the program may be stored or executed by a combination of a main storage device and an auxiliary storage device other than those shown.

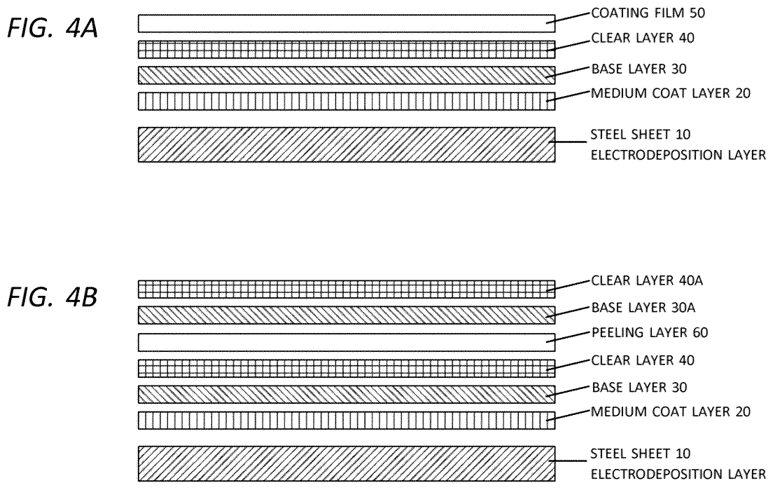

Here, easily peelable paint will be described. FIG. 4A is a schematic cross-sectional view indicating a body member (for example, a steel sheet) having a vehicle body and a coating film formed on the body member. As shown, the body member includes a metal processed steel sheet 10 on which an electrodeposition layer is formed, a medium coat layer 20 formed sequentially on the electrodeposition layer, a base layer 30, and a clear layer 40.

The base layer 30 is a base layer for painting. The base layer 30 may be a pearl layer, a mica layer, or a glass flake layer.

In this example, an example in which the base layer 30 is one layer is shown is shown, but the base layer 30 may have two or more layers of coating film. When the base layer 30 is two layers, the coating film layer is four layers together with the medium coat layer 20 and the clear layer 40.

Further, the base layer 30 and the clear layer 40 may be provided again on the clear layer 40.

A coating film 50 is formed on the outer surface of the body member. The coating film 50 is a layer of paint formed by painting an easily peelable paint, and has the property that it can be easily peeled off by applying force compared to a normal coating film. The coating film 50 is formed by, for example, painting an easily peelable paint on a body member by a spray method. Examples of the easily peelable paint include a paint made of xylene, ethylbenzene, antioxidant, methyl ethyl ketone, silica reactant, titanium oxide (nanoparticles), and an organic solvent.

In addition, when it is necessary to have weather resistance, scratch resistance, and chipping properties in the coating of the vehicle, a coating film 50 having each function can also be applied.

The top coat of the vehicle with the easily peelable paint can be performed at a predetermined base before the vehicle is shipped. Thereby, the body color of the vehicle can be easily changed (ie, changed from the first body color to the second body color). The same applies to the peeling of the coating film 50. By peeling off the coating film 50 at a predetermined base, the vehicle body color can be returned to the original one (that is, it can be returned from the second body color to the first body color). The original paint is protected by coating film 50, so you can get a used car with a deteriorating body paint.

Note that painting with the coating film 50 does not need to be performed on all body members. For example, it is not necessary to provide the coating film 50 for portions that are not exposed to the outside during driving, such as the inside of an opening such as a door.

In this example, a steel sheet has been exemplified as a body member, but the body member may be a resin member. In this case, the medium coat layer 20 becomes a primer layer. Further, a clear layer may be provided on the coating film 50.

In the example of FIG. 4A, the paint itself has been given easy peelability, but normal coating may be applied on a layer having easy peelability. For example, as shown in FIG. 4B, an peeling layer 60 may be formed by the same material as the coating film 50, and the base layer 30A and the clear layer 40A may be formed on the peeling layer 60. The base layer 30A is a layer of paint having a different color from the base layer 30. Even in such a form, the paint layer can be removed by peeling off the peeling layer 60.

In this example, one color is illustrated as the first body color and the second body color, but the first body color and the second body color may be composed of a plurality of colors. For example, a plurality of colors arranged in a predetermined pattern may be a first body color or a second body color. Further, the overcoating according to the second body color may be performed on at least a part of the coating according to the first body color. That is, the overcoating coat by the second body color may not cover all of the painting according to the first body color. For example, when the first body color is black, a vehicle having a two-tone color of black and blue can be obtained by applying a blue top coat to a part thereof.

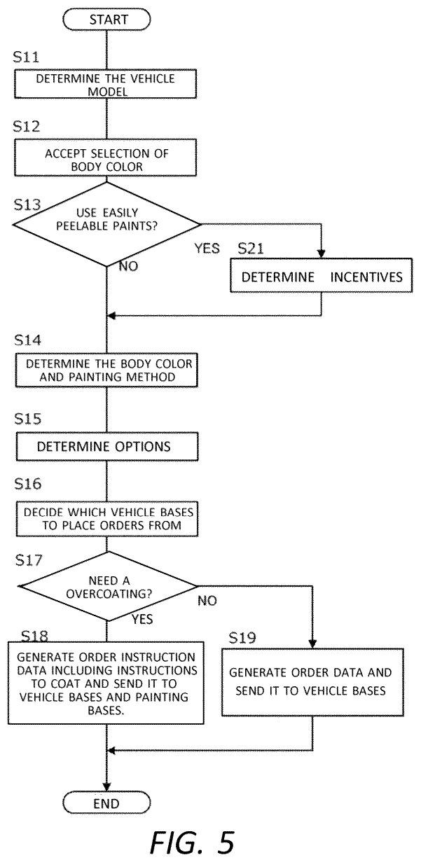

FIG. 5 is a flowchart showing a process executed by the contract server 100. The process shown in FIG. 5 is started, for example, when a user logs in to the contract server 100. At the timing of starting the illustrated process, the contract server 100 assumes that user identification has been completed.

The processing of steps S11˜S15 is executed by the specification determination unit 1011.

In step S11, the vehicle model is determined. In this step, the user selects the desired vehicle model from a plurality of preset vehicle models.

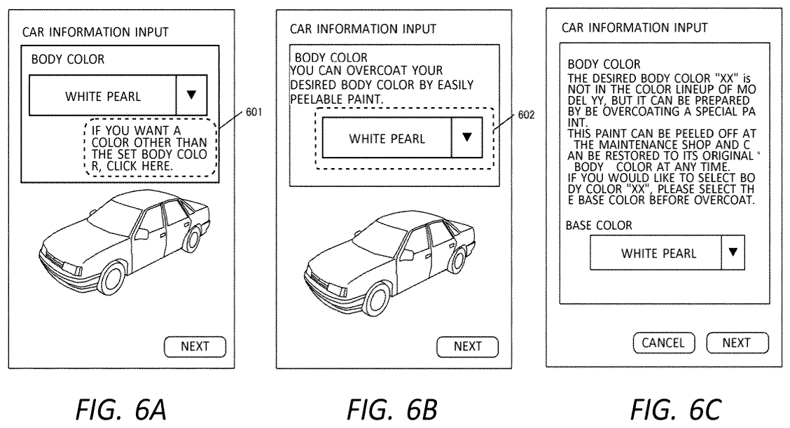

In step S12, a list of body colors corresponding to the target vehicle is generated and presented to the user. The list of body colors corresponding to the target vehicle may be a list of base colors set for the target vehicle, or a list of colors of easily peelable paint that can be overcoated on the target vehicle. The former can be generated based on the basic color data 102B, and the latter can be generated based on the top coat color data 102C. At this time, a color sample may be presented at the same time. FIG. 6A is an example of a vehicle body color selection screen presented to a user via a user terminal 200.

In the present embodiment, the specification determination unit 1011 first presents a list of base colors (first body colors) set for the target vehicle. When the user expresses that there is no desired body color in the list of first body colors (for example, when the link 601 indicated by the dotted line in the figure is clicked), the specification determination unit 1011 generates and outputs a list of colors (second body colors) that can be overcoated with an easily peelable paint. FIG. 6B is an example of a screen that includes a list of second body color. The list of the second body color may be presented using a list box (reference numeral 602) or the like, or may be presented using a color picker or the like.

In this example, a list of first body colors and a list of second vehicle body colors are provided in order, but the first body color and the second body color may be provided simultaneously.

For example, in step S12, a graphical user interface including a color chart (color picker) including all first body colors and all second body colors may be generated to accept color selection.

Since the easily peelable paint has a service life, when painting with the easily peelable paint is applied to the vehicle, it is preferable to provide guidance to the user regarding the service life of the paint. For example, following the selection of the body color, a guide regarding the service life of the paint may be output. In addition, if the vehicle is planned to be used beyond its useful life, it may be indicated that it is necessary to peel off the overcoating paint on the way. Further, when the vehicle is planned to be used beyond the service life, it may be suggested to the user that the easily peelable paint is not used.

In step S13, it determined whether or not the body color specified by the user uses an easily peelable paint. For example, when the body color specified by the user is selected from the list of the first body color, this step is a negative judgment, and the process transitions to step S14. If the body color specified by the user is selected from the second body color list, this step becomes an affirmative judgment and the process transitions to step S21.

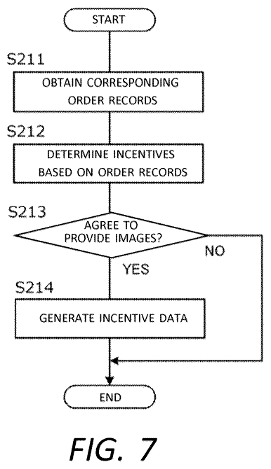

FIG. 7 is a flowchart of the process executed in step S21.

First, in step S211, the order record (order history) in the past predetermined period is acquired for a vehicle having a vehicle model and body color combination specified by the user. The order record of the vehicle in the past predetermined period can be obtained by searching the order data 102A using the order date (for example, within the past 1 year), the vehicle model, and the vehicle body color as keys. As a result, for example, when 100 records are extracted, it can be seen that 100 corresponding vehicles have been ordered in the past predetermined period.

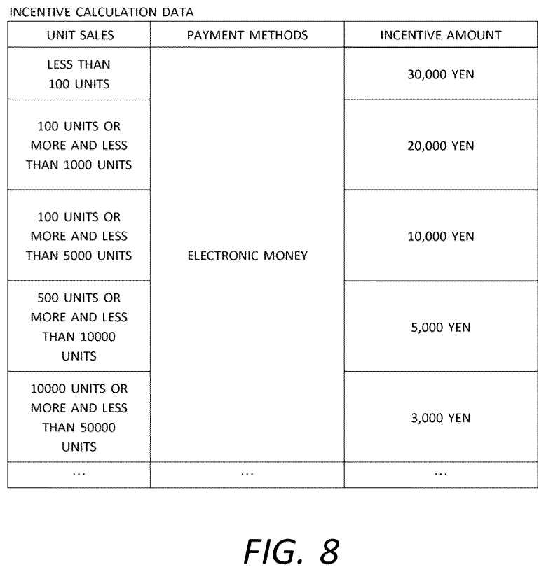

Next, in step S212, the content of the order provided to the user is determined based on the order performance of the vehicle in the predetermined period. In the present embodiment, the more incentives are set for the combination of vehicle models and body colors that have a small number of orders in a predetermined period. The content of the incentive may be determined based on, for example, data as illustrated in FIG. 8 Here, the number of vehicles is used as the order record, but other indicators (for example, amounts) may be used.

Next, in step S213, the user is confirmed as having consented to the image provision.

In this step, we inquire whether it is possible to provide an image taken of the appearance of the purchased vehicle as a sample image. In this step, the contents of the incentive to be provided may be presented at the same time.

When a positive determination is made in this step, that is, when the consent of the user is obtained, the process transitions to step S214. If consent is not obtained, the process in step S21 is terminated.

In step S214, incentive data indicating the incentive determined in step S212 is generated. The incentive data is data for instructing an external device to provide an incentive, including a user identifier and the content of the incentive. The generated incentive data is sent to an external device that manages points, electronic money, etc. when the vehicle order is completed, and incentives are given to the user thereby.

Return to FIG. 5 and continue the explanation.

If the use of an easily peelable paint is not specified, the specification determination unit 1011 determines to order a vehicle having the specified body color as the base color in step S14.

When the use of an easily peelable paint is specified, the specification determination unit 1011 orders a vehicle having an arbitrary first body color as the base color in step S14 and determines to overcoat the specified vehicle body color.

When a overcoating is performed with an easily peelable paint, the contract server 100 may determine the first body color based on a predetermined standard. For example, the following can be adopted as predetermined standards.

(1) Among the plurality of body colors, determine the body color that is expected to be the most expensive at a given point in the future as the first body color.

(2) Determine one of the body colors that is expected to be higher than the predetermined value at a predetermined point in the future as the first body color.

In general, the color of a body color with a high price is determined by its popularity in the used car market. For example, body colors that include pearl layers and pearl mica layers are more popular than other body colors and tend to have higher valuations. The predetermined value can be a value based on the new car price of the target vehicle model. For example, the first body color can be a color whose valuation after three years is higher than 65% of the price of a new car. The first body color is preferably a body color having a higher valuation value than the second body color.

The contract server 100 may store a database or the like for acquiring the expected valuation for each body color at a predetermined point in the future. Further, the contract server 100 may appropriately determine a predetermined point in the future.

In the above-described example, the contract server 100 has determined the first body color, but the user may select the first body color. FIG. 6C is an example of a screen for allowing a user to select the first body color. At this time, the contract server 100 may present the expected valuation of the vehicle after a predetermined period has elapsed for each body color as reference information.

By the processing so far, the body color and the coating method thereof are determined.

In step S15, the selection of options incidental to the vehicle is accepted. In this step, for example, the selection of manufacturer options such as safety equipment and dealer options such as in-vehicle terminals are accepted.

When the specifications of the vehicle are determined, order data is generated and stored according to the determined specifications.

In step S16, the ordering unit 1012 determines the vehicle base to which the vehicle is ordered. In this step, for example, the inventory of the vehicle with the specifications indicated by the order data is confirmed, and after determining whether to deliver the stock vehicle or perform new production, the vehicle base to be ordered is determined.

Next, in step S17, the ordering unit 1012 determines whether or not a overcoating is necessary. When a overcoating is required is, for example, when both the first body color and the second body color are specified in the order data.

When only the first body color is specified for the target vehicle, the ordering unit 1012 generates order instruction data and transmits the order instruction data to the vehicle base that supplies the vehicle (step S18). When both the first body color and the second body color are specified for the target vehicle, the ordering unit 1012 generates order instruction data including a painting instruction, and transmits the order instruction data to the vehicle base that supplies the vehicle and the coating base where the vehicle is overcoated (step S19).

The order instruction data includes vehicle specifications (including the first and second body colors) as well as the designation of a coating base for overcoating.

The coating base for performing the overcoating may be, for example, a dealer, an inspection center, a maintenance shop, or the like. The vehicle base and the coating base may be the same.

The ordering unit 1012 may determine the delivery date of the vehicle when the vehicle having the determined second body color is coated with a top coat of the determined first body color. For example, the ordering unit 1012 may determine the delivery date of the requested vehicle and present it to the user. When the transmission of the order instruction data is completed, the contract server 100 may notify the user that the vehicle order has been completed.

The vehicle base that receives the order instruction data for overcoating prepares (or produces) a vehicle having the first body color, and if necessary, overcoats it with the second body color before delivering it to the user. Painting with the second body color can be performed at the designated coating base. In addition, when the vehicle base where the vehicle is prepared (or produced) and the coating base are different, the vehicle may be forwarded.

A vehicle base that receives order instruction data stating that overcoating is not performed may prepare (or produce) a vehicle having the first body color and deliver it to the user.

As described above, in the vehicle ordering system according to the first embodiment, the content of the incentive to be given to the user is determined as a criterion for determining whether or not the body color selected by the user is rare. As a result, when a rarer body color is selected, it is possible to give more incentives to the user. By using this incentive as a consideration for providing exterior images of vehicles, it can be expected that more exterior images will be collected.

(Modification of the First Embodiment)

In the first embodiment, after the body color is determined, the content of the incentive provided to the user is determined, but the content of the incentive may be presented to the user in the step of selecting the body color. For example, in step S12, when generating a list of body colors, the presence or absence of incentives and their contents may be acquired for each body color. Further, when each body color is selected, information that guides what kind of incentive can be received may be output.

(Modification)

The above embodiment is only an example, and the present disclosure can be appropriately changed and implemented within the range that does not deviate from the gist thereof.

For example, the processes and means described in the present disclosure can be freely combined as long as no technical contradiction occurs.

Further, in the description of the embodiment, a form in which the vehicle is sold to a user has been exemplified, but the information processing apparatus according to the present disclosure can be applied to a form other than sales, such as lending.

Further, the process described as being performed by one device may be shared and executed by a plurality of devices. Alternatively, the process described as being performed by different devices may be performed by one device. In a computer system, the hardware configuration (server configuration) by which each function is realized can be flexibly changed.

The present disclosure can also be realized by supplying a computer program implementing the functions described in the above embodiment to a computer, and one or more processors owned by the computer reading and executing the program. Such computer programs may be provided to a computer by a non-transitory computer-readable storage medium that can be connected to the computer's system bus, or may be provided to a computer over a network. Non-transitory computer-readable storage media include, for example, magnetic disks (floppy (registered trademark) disks, hard disk drives (HDDs), etc.), optical discs (any type of disk such as CD-ROM, DVD discs, Blu-ray discs, etc.), read-only memory (ROM), random access memory (RAM), EPROM, EEPROM, magnetic cards, Includes flash memory, optical cards, any type of medium suitable for storing electronic instructions.

What is claimed is:

1. An information processing apparatus comprising a controller configured to execute:
as a specification of a vehicle to be ordered, receiving order data specifying a first body color and a first vehicle model from a user, and
determining a content of an incentive to be provided to the user based on order records of the first vehicle model having the first body color in a past predetermined period.

2. The information processing apparatus according to claim 1, wherein
the controller increases amount of the incentive as order amount of the first vehicle model having the first body color in the past predetermined period is smaller.

3. The information processing apparatus according to claim 2, wherein
the controller determines to provide the incentive to the user on condition that the user agrees to provide an external image of the vehicle having the first body color.

4. The information processing apparatus according to claim 2, wherein
the controller acquires the order amount of the first vehicle model in the past predetermined period by body color.

5. The information processing apparatus according to claim 2, wherein
the controller determines to provide the incentive to the user on condition that the specified first body color is a body color realized by applying an easily peelable paint to the vehicle.
